(19) United States
(12) Patent Application Publication
(10) Pub. No.: US 2022/0058180 A1
(43) Pub. Date: Feb. 24, 2022

(54) METHOD, APPARATUS AND SYSTEM FOR TRANSACTIONS

(71) Applicant: Dev Null Productions LLC, DeWitt, NY (US)

(72) Inventor: Mohammed Morsi, Phoenix, NY (US)

(21) Appl. No.: 17/341,856

(22) Filed: Jun. 8, 2021

Related U.S. Application Data
(60) Provisional application No. 62/706,491, filed on Aug. 20, 2020.

(51) Int. Cl. G06F 16/23; G06F 16/27

(52) U.S. Cl. CPC G06F 16/2379; G06F 16/27

(57) ABSTRACT

Embodiments of the present disclosure provide method, apparatus, and computer-readable medium for filtering. An exemplary method includes monitoring, by a processor, at least one of a plurality nodes of at least one of a plurality of digital distributed ledger systems, and receiving a filtering expression from a user equipment (UE), the filtering expression comprising search parameters for identifying future transactions on the at least one of a plurality of digital distributed ledger systems. The method further includes detecting a plurality of transactions on the at least one of a plurality of digital distributed ledger systems at the at least one of a plurality of nodes, determining that at least one of the plurality of transactions on the at least one of a plurality of digital distributed ledger systems at the at least one of a plurality of nodes has a correspondence with the filtering expression, and storing a first data to at least one of a plurality of UEs.

### BACKGROUND OF THE INVENTION

### Field of the Invention

Embodiments of the present disclosure relate to transactions, and more particularly to a method, apparatus and system for monitoring transactions.

### Description of Related Art

Digital distributed ledgers generally comprise multiple computers, nodes, servers and the like that each maintain copies of a ledger and collectively approve entries or additions to the ledger. A blockchain is a type of digital distributed ledger that is typically managed by a peer-to-peer network. Each of the devices that are members of the peer-to-peer network will all abide by a common protocol for communication and the creation and validation of new blocks on the blockchain. A blockchain is resistant to modification and falsification of the transactions memorialized in its blocks due to the cryptographic nature of the blocks and the fact that a significant number of nodes within the network would need to be compromised. Due to this resistance, blockchain technology has proven particularly applicable in instances in which unrelated parties desire to transact business.

### BRIEF SUMMARY OF THE INVENTION

In view of the foregoing, it is an object of the present disclosure to provide a method and apparatus.

A first exemplary embodiment of the present disclosure provides a method of monitoring. The method includes monitoring, by a processor, at least one of a plurality nodes of a at least one of a plurality of digital distributed ledger systems, and receiving, by the processor, a filtering expression from a user equipment (UE), the filtering expression comprising search parameters for identifying future transactions on the at least one of a plurality of digital distributed ledger systems. The method further includes detecting, by the processor, a plurality of transactions on the at least one of a plurality of digital distributed ledger systems at the at least one of a plurality of nodes, and determining, by the processor, that at least one of the plurality of transactions on the at least one of a plurality of digital distributed ledger systems at the at least one of a plurality of nodes has a correspondence with the filtering expression. The method still further includes storing, by the processor, the at least one of the plurality of transactions.

A second exemplary embodiment of the present disclosure provides an apparatus. The apparatus comprising at least one processor and at least one memory storing computer program instructions executable by the at least one processor, wherein the at least one memory with the computer program instructions and the at least one processor are configured to cause the apparatus to at least monitoring, by a processor, at least one of a plurality nodes of a at least one of a plurality of digital distributed ledger systems. The apparatus is further caused to at least receive a filtering expression from a user equipment (UE), the filtering expression comprising search parameters for identifying future transactions on the at least one of a plurality of digital distributed ledger systems, and detect a plurality of transactions on the at least one of a plurality of digital distributed ledger systems at the at least one of a plurality of nodes. The apparatus is still further cause to at least determine that at least one of the plurality of transactions on the at least one of a plurality of digital distributed ledger systems at the at least one of a plurality of nodes has a correspondence with the filtering expression, and transmit a first data to the UE, the first data comprising at least one alert to notify a user of the UE of the at least one of the plurality of transactions.

A third exemplary embodiment of the present disclosure a non-transitory computer-readable medium. The non-transitory computer-readable medium tangibly storing computer program instructions which when executed by a processor, cause the processor to at least monitor at least one of a plurality nodes of a at least one of a plurality of digital distributed ledger systems. The processor is further caused to receive a filtering expression from a user equipment (UE), the filtering expression comprising search parameters for identifying future transactions on the at least one of a plurality of digital distributed ledger systems, and detect a plurality of transactions on the at least one of a plurality of digital distributed ledger systems at the at least one of a plurality of nodes. The processor is still further caused to determine that at least one of the plurality of transactions on the at least one of a plurality of digital distributed ledger systems at the at least one of a plurality of nodes has a correspondence with the filtering expression, and transmit a first data to the UE, the first data comprising at least one alert to notify a user of the UE of the at least one of the plurality of transactions.

A fourth exemplary embodiment of the present disclosure presents a method. The method includes receiving, by the processor, a filtering expression from a user equipment (UE), the filtering expression comprising search parameters for identifying future transactions on the digital distributed ledger system, determining, by the processor, that at least one of the plurality of transactions from a blockchain datastore has a correspondence with the filtering expression, and transmitting, by the processor, the at least one of the plurality of transactions to the UE.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 presents a block diagram of an exemplary system suitable for use in practicing exemplary embodiments of the present disclosure.

FIG. 2 presents an exemplary logic flow diagram suitable for use in practicing exemplary embodiments of the present disclosure.

FIG. 2A presents a simplified logic flow diagram suitable for use in practicing exemplary embodiments of the present disclosure.

FIG. 3 presents an exemplary signaling diagram suitable for use in practicing exemplary embodiments of the present disclosure.

FIG. 4 presents another exemplary signaling diagram suitable for use in practicing exemplary embodiments of the present disclosure.

FIG. 5 presents yet another exemplary signaling diagram suitable for use in practicing exemplary embodiments of the present disclosure.

FIG. 6 presents an alternative exemplary signaling diagram suitable for use in practicing exemplary embodiments of the present disclosure.

FIG. 7 presents another alternative exemplary signaling diagram suitable for use in practicing exemplary embodiments of the present disclosure.

FIG. 8 presents yet another alternative exemplary signaling diagram suitable for use in practicing exemplary embodiments of the present disclosure.

FIG. 9 presents application of an exemplary filtering expression suitable for use in practicing exemplary embodiments of the present disclosure.

FIG. 10 presents an exemplary logic flow diagram in accordance with an exemplary method or process suitable for practicing exemplary embodiments of this disclosure.

FIG. 11 presents another exemplary logic flow diagram in accordance with an exemplary method or process suitable for practicing exemplary embodiments of this disclosure.

FIG. 12 presents yet another exemplary logic flow diagram in accordance with an exemplary method or process suitable for practicing exemplary embodiments of this disclosure.

FIG. 13 presents another exemplary signaling diagram suitable for use in practicing exemplary embodiments of the present disclosure.

FIG. 14 presents an exemplary signaling diagram between a server and a user equipment suitable for use in practicing exemplary embodiments of the present disclosure.

FIG. 15 presents an exemplary sequencing diagram suitable for use in practicing exemplary embodiments of the present disclosure.

### DETAILED DESCRIPTION OF THE INVENTION

On each blockchain there is a great deal of information and data that can be useful to a user. However, there is a vast amount of information available from the blockchain. This causes the usefulness of the information to very limiting because the user cannot appropriately extract the relevant information form the irrelevant information. As such, there is a need for improvements to make blockchain transactions more useful. Embodiments of the present disclosure may include at least one computer with a user interface. The computer may include at least one processing unit coupled to a form of memory. The computer may include, but is not limited to, a microprocessor, a server, a desktop, laptop, and smart device, such as, a tablet and smart phone. The computer may include a program product including a machine-readable program code for causing, when executed, the computer to perform steps. The program product may include software which may either be loaded on the computer or accessed by the computer. The loaded software may include an application on a smart device. The software may be accessed by the computer using a web browser or network interface. The computer may access the software via the web browser or network interface suing the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

As stated above, a multitude of transactions are processed by blockchain technologies on a continuous basis. In an exemplary embodiment of the present invention, a system is provided which may solve the problem users face in having to manually monitor all transactions to be notified of transactions of interest. The present invention solves this problem by providing a system which may allow users to specify a filtering expression to represent the transactions in which they are interested. The system and software of the system may process all blockchain transactions in real-time or on a batch basis, dynamically applying user expressions to each, and notifying the user of those that match.

The system of the claimed invention differs from and distinguishes over what currently exists. Current blockchain monitoring solutions are very limited in nature. Embodiments of the present invention may allow the user to set up expressions that may be used to match against any data in a transaction. Embodiments of the present invention may address the complexities and nuances of data that is represented in transactions, and eliminate the need for users to fall back to and resort to manual processing of transaction to find the information and activity in which they are interested.

Exemplary embodiments of the present invention may use an expression language that facilitates honing-in on exactly the data and content that the end user would like to match and/or omitting the data and content that the end user would like to exclude. The user may specify any field or combination of fields, along with comparative, logic, and arithmetic operators to be notified of the exact transactions in which they are interested.

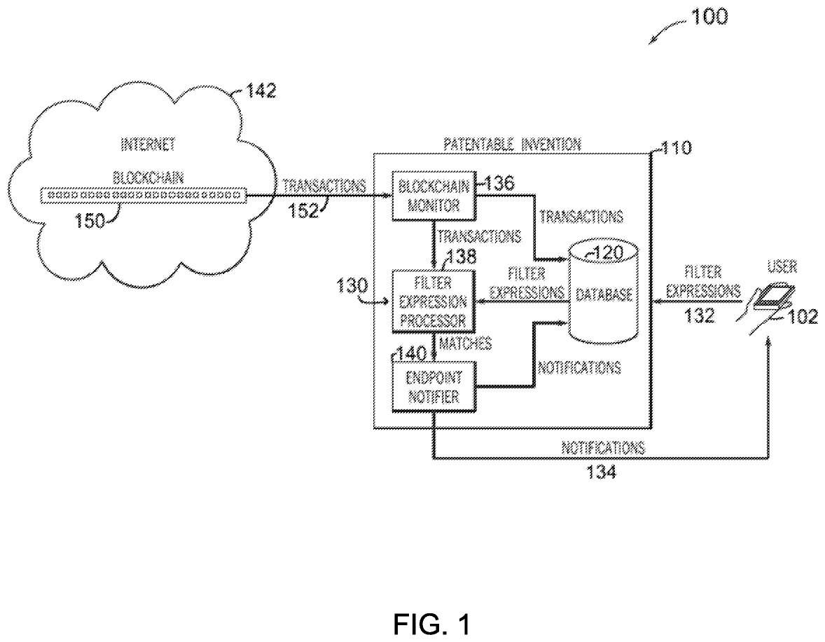

Reference is now made to FIG. 1, which illustrates a block diagram of an exemplary system suitable for practicing exemplary embodiments of this disclosure. FIG. 1 shows a system 100, which includes a computer 110 having a processing and networking capabilities and a database system 120 installed on the computer 110. The database system 120, residing in the memory and/or on the disk, is capable of continuously storing filtering expressions 132 specified by user 102 and notification endpoints 134. The system 100 further includes computer-readable medium 130 storing an application.

Embodiments of the system 100 include filter expressions 132 specified by a user 102, notification endpoints 134 specified by the user 102, a blockchain monitor 136, a filter expression processor 138, an endpoint notifier 140, and a connection to the internet 142 for access to a blockchain 150 in order to monitor blockchain transactions 152.

The database 120 and software 130 may be installed on the computer 110 and initiated. The computer may be processing device as heretofore noted. End user 102 may connect via a network connection and specify filter expressions 132 and notification endpoints 134 that are stored in the database 120. As blockchain transactions 152 are matched, they may be processed by filters read from the database 120. If they are not matched, they may be discarded. If the blockchain transactions 152 are matched, they may be stored in the database 120 until a specified number have been accumulated or a specified time has elapsed. The end user may then be notified via the endpoints read from the database by an endpoint notifier 140.

In an exemplary embodiment of the present disclosure, the present invention may operate as follows. Embodiments may store at least one user filter specified via JSONPath in the database. JSON Path is an expression language facilitating the querying of any document structured in the JSON format. Embodiments may ensure that the user input is valid JSONPath syntax before storing. If the user input is not valid JSONPath syntax or does not satisfy security or complexity requirements, the software may reject the operation and return an error. It should be appreciated that embodiments provide for the use of any type of programming language operable to allow a user to create filtering expressions. Some non-limiting embodiments of such programming languages include xpath, sql, programming languages, and the like.

Embodiments include storing at least one notification endpoint (notification endpoints are also referred to internally as “sinks”) in the database, and may associate the notification endpoint with filters in compliance with user specification. The format of each notification endpoint may be validated before it is stored. If the format of an endpoint is invalid, the software may reject the operation and return an error.

In an exemplary embodiment of the present invention, filters, sinks, and associations may be specified by authenticated users via an Application Programming Interface (API), graphical interface, text-based interface, direct connection, network connection, database connection, inter-process communication, or other means.

In an exemplary embodiment of the present invention, in addition to the database, connection, and communication logic, it may be composed of at least one worker process. In an exemplary embodiment, it may comprise multiple worker processes which may serve different roles in the transaction matching system.

In one embodiment, one worker process may open a network connection to a blockchain node and listen for incoming transactions sent to it. Once transactions are received, they may be stored in the database.

In one embodiment, another worker process may read transactions and filter expressions from the database and apply the expressions to the transactions. When applied, the expression processing logic may yield a Boolean output corresponding to if the expression matches or does not match the given transaction. Transactions that are not matched by any filter may be discarded. Transactions that are matched may be stored in the database with the identifiers of the filter(s) which yielded positive results.

In one embodiment, another worker process may read matched transactions from the database and send notifications to the endpoints associated with the filter. Depending on the type of endpoint, these notifications may be formatted differently.

In one embodiment, once all setup is complete, and transactions are being processed and user filters and notification endpoints are stored, each filter expression may be applied to each received transaction. If the filtering expression is matched, end-users may be notified via the specified endpoint(s), otherwise the transactions may be discarded.

Embodiments include a user-friendly interface can be included to assist in filter and endpoint creation and associating endpoints with filters. Deploying the expression matching logic to multiple computers and coordinating transaction processing may improve scalability and increase throughput. Additional components to generate expressions, either via manual specification or through an automated process, may be deployed to assist the end user.

Embodiments of the present disclosure may match transactions as they are propagated across the blockchain network against filters existing in the database. Thus, any filter needs to have been created before transactions are sent that yield positive matches. One embodiment of the present invention may provide analysis of historical transactions. Embodiments include that newer filters are applied to historical transactions and the user may receive notification of matching transactions which were included in the blockchain before the filters were created. Embodiments include having additional notification endpoints and alternate means of access.

Embodiments include the ability for the user to specify a filter expression to be stored in the database which may match the types of transactions that they are interested in. The user may craft an expression to be notified of at least one blockchain transaction. For example, without limitation, the user may craft an expression to be notified of a blockchain transaction originating from a specific account (or multiple accounts), a blockchain transaction being sent to a specific account (or multiple accounts), a blockchain transaction transacting a specific currency (or currencies), a blockchain transaction paying a minimum or maximum fee, any combination of the above, and more. The end user may specify at least one endpoint through which the user would like to be notified of said transactions.

Upon transactions being matched, the end user may be notified via the specified endpoint at which point they can perform subsequent action, such as alerting authorities in the case of unauthorized access, sending merchandise in case of a store payment, creating an exchange order in the case of market activity, and/or any number of subsequent actions.

Additionally, in an exemplary embodiment, the present invention may be incorporated into multiple types of systems. For example, without limitation, the system of the present invention may be incorporated into forensics and malicious activity detection systems, automated trading and market activity systems, and network health and status monitoring systems. Endpoints may be created in any of these domains or additional domains to launch subsequent processes depending on detected activity.

Embodiments of the present disclosure may provide a system, a method, or apparatus to match blockchain transactions for further processing. Embodiments of this disclosure may use an expression language that facilitates honing-in on exactly the data and content that the end user would like to match and/or omitting the data and content that the end user would like to exclude. The user may specify any field or combination of fields, along with comparative and logic operators to be notified of the exact transactions they are interested in.

Exemplary embodiments of the present disclosure may include a process or method for matching blockchain transactions for further processing using the system 100. An exemplary process includes (1) initiating the blockchain monitoring, (2) allowing authenticated users to store filtering expressions in a database, (3) processing each blockchain transaction individually, applying stored expressions against transaction, (4) discarding unmatched transactions, and (5) notifying the user of matched transactions via one or more mechanisms (e.g., by email, SMS, webhook or the like). Other exemplary embodiments facilitate processing one or more sets of blockchain transactions, each consisting of at least one of a plurality of blockchain transactions to be processed together.

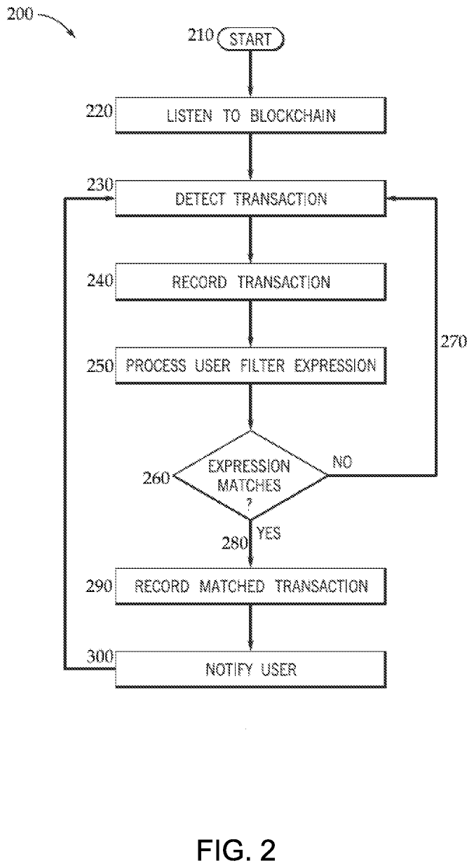

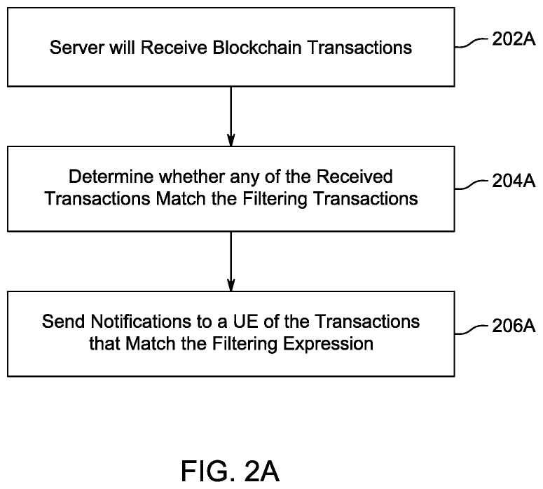

FIG. 2 depicts an exemplary logic flow diagram in accordance with a method or process 200 suitable to practicing embodiments of this disclosure. The process begins at the start at block 210. Next block 220 specifies listen to blockchain. Then block 230 states detect transaction. Block 240 indicates record the transaction. Then at block 250 user filter expression is processed. At block 260, it is determined whether the expression matches the recorded transaction. If the expression does not match, the transaction is discarded, and the process is returned to block 230. If the expression matches, then the process proceeds to block 290 and the matched transaction is recorded. Then at block 300, the user is notified and the process returns to block 230 for detection of at least one additional transaction.

Referring to FIG. 2A, shown is a simplified logic flow diagram in accordance with a simplified method or process 200A suitable for performing exemplary embodiments of this disclosure. An exemplary process begins at block 202A, which states that the server will receive blockchain transactions. The server will monitor blockchain transactions at one or more blockchain nodes and will receive blockchain transactions from the monitored blockchain node. Next at block 204A, the server will apply a filtering expression to the received blockchain transactions to determine whether any of the received transactions match the filtering transactions. Finally, at block 206A will send notifications to a UE of the transactions that match the filtering expression. It should be appreciated that embodiments include the matching transactions being maintained within the server until they are retrieved by a UE at which point the server will send them to the particular UE that requests them.

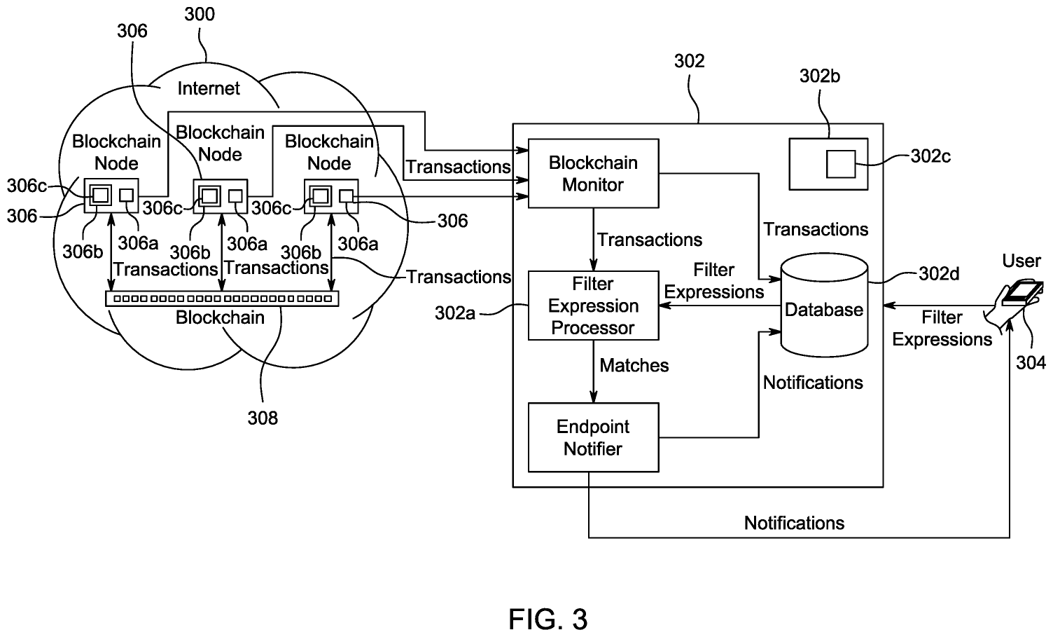

Reference is now made to FIG. 3, which illustrates an exemplary signaling diagram suitable for practicing exemplary embodiments of the present disclosure. Shown in FIG. 3 is internet 300, server 302, and user equipment (UE) 304. Internet 300 includes a plurality of servers 306 that each are operable to maintain a separate copy of a digital distributed ledger 308. Embodiments of a digital distributed ledger 308 include a record of transactions that are maintained by a plurality of entities (e.g., servers) that are each operable to keep track of transactions and are operable to communicate with one another such that they can collectively agree or reach consensus that each of the transactions recorded on the digital distributed ledger 308 are correct. Embodiments of a digital distributed ledger 308 include a blockchain. Each of the plurality of servers 306 may also be referred to individually as nodes or blockchain nodes and collectively as a digital distributed ledger system. Each one of the plurality of servers 306 are operable to maintain a copy of the digital distributed ledger 308. It should be appreciated that the plurality of servers 306 may be located at the same or at multiple locations. Embodiments of the plurality of servers 306 each include a processor 306a and a memory 306b storing computer program instructions 306c operable to cause the processor to receive transactions from a plurality of sources, effectuate the transactions, record the transactions on a digital distributed ledger 308 and maintain a copy of the digital distributed ledger 308. It should be appreciated that even though FIG. 3 only depicts three servers 306, embodiments include one or more servers 306. The plurality of servers or nodes 306 that record transactions to and otherwise maintain the digital distributed ledger 308 may be referred to herein as a digital distributed ledger system.

Server 302 includes at least one processor 302a and at least one memory 302b storing computer program instructions 302c, which when executed by the processor 302a causes the processor 302a to perform embodiments of this disclosure. Embodiments of server 302 are operable for bidirectional communication with internet 300 and at least one of the plurality of servers 306. In one embodiment, server 302 is operable to communicate with only one of the nodes 306. In another embodiment, server 302 is operable to communicate with more than one of servers 306. Embodiments of server 302 are operable to monitor or receive transactions as they either are effectuated on the digital distributed ledger 308 by the node or nodes 306 in communication with server 302 or when they are received by one or more of the nodes 306. In one embodiment, server 302 only receives the transactions from one or more of the nodes 306 after all of the nodes 306 have reached consensus that a particular transaction is valid and such transaction is included in or added to the digital distributed ledger. In another embodiment, server 302 receives the transactions from one or more of the nodes 306 prior to the nodes 306 reaching consensus that a particular transaction is valid or the inclusion of the transaction in the digital distributed ledger. It should be appreciated that valid refers to whether the transaction is in compliance with the established governance rules in effect on the distributed ledger system, for example, the sender has the amount of currency being sent (bitcoin, XRP, Ethereum, USD, etc.).

Server 302 is operable for bidirectional communication with a UE 304. Embodiments of UE 304 include a computer, desktop, laptop, smartphone, mobile phone, tablet, wearable or smart watch and the like. Embodiments of UE 304 include at least one processor and at least one memory storing computer program instructions, which when executed by the at least one processor causes the at least one processor to perform the functions described herein. UE 304 may also include a user interface having a display that can receive and transmit data and information to a user.

Embodiments of UE 304 are operable to maintain a list of predetermined filtering expressions. Embodiments of server 302 are also operable to maintain the list of predetermined filtering expressions. An exemplary filtering expression provides search characteristics for identifying past, current, or future transactions on the digital distributed ledger 308. In one embodiment, the filtering expression provides search parameters for identifying past, current, or future transaction on the digital distributed ledger 308 through the use of mathematical operators. For example, an exemplary filtering expression may include (i) transactions greater than a certain user determined amount, (ii) transactions that create new accounts, (iii) transactions that are less than a certain user determined amount, (iv) transactions involving the buying or selling of a particular asset (e.g., BTC vs. XRP), and (v) transactions originating from a specified source or account. In one embodiment a filtering expression provides for parameter filtering to identify transactions on the digital distributed ledger 308 based on at least one of (i) users involved in transactions, (ii) sender of payment, (iii) receiver of payment, (iv) currency payor, (v) location of nodes used in the transaction, (vi) transaction fee charge, (vii) number of blocks including in the transaction, and (viii) location of transaction within the digital distributed ledger system. In another embodiment, UE 304 and/or server 302 are operable to allow a user to create a filtering expression (as opposed to choosing or selecting a predetermined filtering expression). Embodiments of server 302 provide that memory 302b can maintain the filtering expressions created or identified by a user. As shown in FIG. 3, server 302 includes a database 302d which is maintained on memory 302b and is operable to save or maintain the filtering expressions.

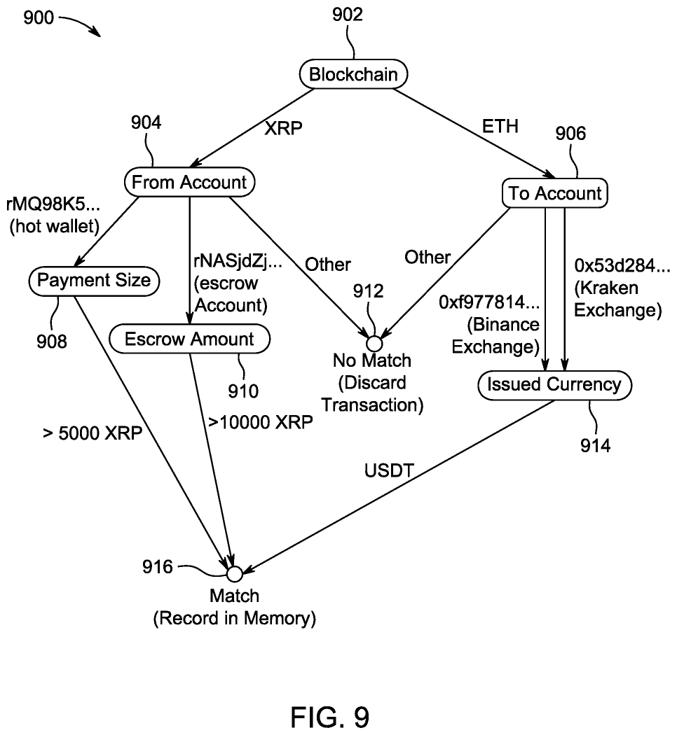

Another exemplary embodiment, an exemplary filtering expression can include a filter graph. A filter graph provides a logic flow analysis for the filtering of transactions. An exemplary filtering graph 900 is shown in FIG. 9. Each transaction is processed through the logic flow analysis of the filter graph to determine whether there is a match. For example, in filtering graph 900 a transaction will occur on the blockchain at block 902 and the transactions are separated into transactions that involve XRP and ETH. Transactions (for this example) that do not involve XRP or ETH will be removed from further analysis in the filtering graph 900. At block 904, XRP transactions will be further narrowed by the account that the transactions are moving the funds from. If a transaction is from a particular account then it will be further analyzed in the filtering graph 900. If a transaction is not from a particular account then it will be removed from further analysis at dot 912. Similarly, at block 906, ETH transactions will be further narrowed by the account that the transactions are moving the funds to. If a transaction is made to a particular account then it will be further analyzed in the filtering graph 900. If a transaction is not made to a particular account then it will be removed from further analysis at dot 912. At block 908, XRP transactions will be further narrowed by the size of the payment. In the example shown in FIG. 9, payments for more than 5000 XRP will be considered a match. Payments for equal to or less than 5000 XRP will not be considered a match. At block 910, XRP transactions will be further narrowed by the escrow amount. In the example shown in FIG. 9, transactions with an escrow amount for more than 10,000 XRP will be considered a match. Transactions with an escrow amount for equal to or less than 10,000 XRP will not be considered a match. At block 914, transactions filtered through block 906 will be further filtered by transactions involving US dollars, which will be considered a match. It should be appreciated embodiments of a filtering graph allow a user filter transactions from a blockchain through a series of filtering steps that continually narrow the transactions that match. It should be also be appreciated that embodiments include altering the order of the filtering steps. It should be further appreciated that the each of the blocks depicted in FIG. 9 are merely non-limiting implementations of an exemplary filtering graph.

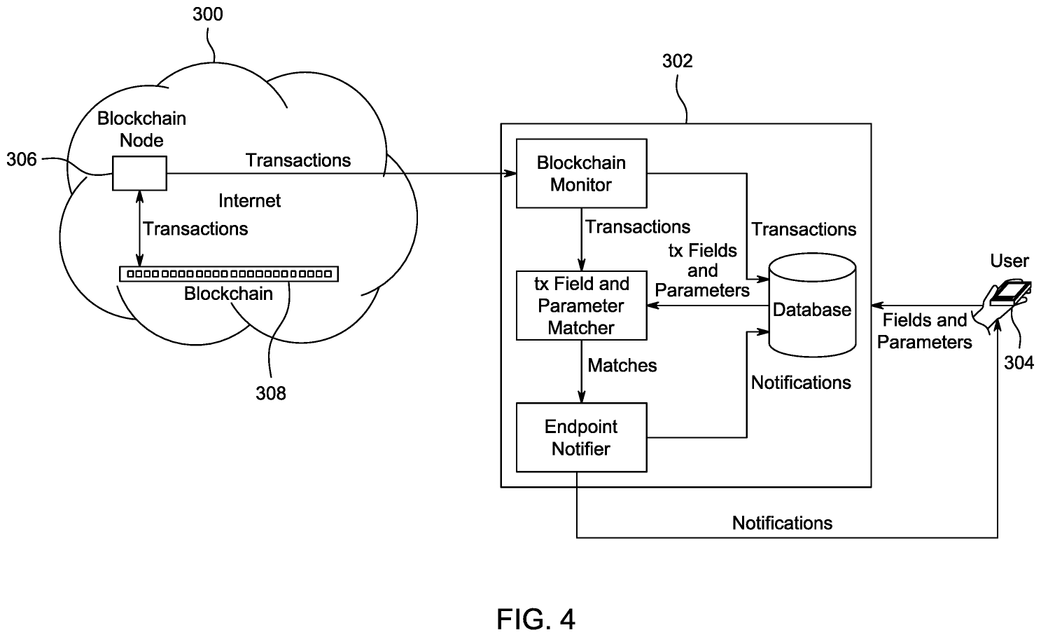

While monitoring one or more of the nodes 306 of the digital distributed ledger 308, server 302 is operable to detect one or more transactions on the digital distributed ledger 308. FIG. 4 illustrates an exemplary block diagram in which server 302 is monitoring a single node 306 within the distributed digital ledger system. It should be appreciated that while FIG. 4 only depicts a single node 306, the digital distributed ledger system includes a plurality of nodes 306. Accordingly, FIG. 4 merely illustrates server 302 monitoring one of a plurality of nodes 306.

As the server 302 monitors the transactions, embodiments provide that the processor 302a can determine whether the monitored transactions on the digital distributed ledger 308 at the one or more nodes 306 has a correspondence to the filtering expression or expressions identified by a user. It should be appreciated that embodiments include server 302 monitoring current transactions on the digital distributed ledger 308 and/or reviewing past transactions on the digital distributed ledger 308. In the embodiment in which server 302 reviews past transactions, server 302 is operable to receive instructions from UE 304 with particular search parameters including the time period in which transactions should be reviewed. Server 302 will then obtain the transactions from one or more nodes 306 within the specified time period. Upon receipt of the past transactions, Server 302 will proceed to perform the processes described herein as if such transactions were occurring presently.

It should be appreciated that embodiments provide that the processor 306a is operable to identify whether there is a correspondence between one or a plurality of filtering expressions and each transaction that is monitored by server 302. Embodiments of a correspondence includes the transactions matching or falling within the bounds of the filtering expression. For instance, the filtering expression may involve identifying transactions that originated from a node 306 located in India for less than $500. Embodiments include the processor 302a being operable to identify transactions that match or meet these filtering expression parameters. Once the processor 302a has identified one or more transactions having a correspondence to the filtering transactions, server 302 is operable to transmit the transactions and/or an alert to the UE 304 to notify the user of the identified transactions. It should be appreciated that embodiments include server 302 transmitting the transactions and/or an alert to a UE different from the UE 304, which created the filtering expression. Embodiments include server 302 transmitting the transactions and/or alert to one or a plurality of UEs. Some non-limiting embodiments of the alert include at least one of an application programming interface call, chat room message, application notification, external system update (e.g., special purpose notification device, watch, etc.), an application programming interface link, an email, a text message, a phone call, and an instant message.

One embodiment the system allows a user to create a valid syntax of filtering expressions and an input field through which a user can create filtering expressions and view matching transactions as they manifest on a live digital distributed ledger or blockchain. Once the user has created the filtering expression that suits his or her needs. The user is also able to set rules for the notification endpoints for when a match occurs. After that the filtering expression is persisted to the database and when transactions are received from the digital distributed ledger or blockchain, the filtering expression is applied to them and the corresponding matches are sent to the configured notification endpoints. The process of applying filter expressions consists of evaluating them in the context of each transaction, and determining if the filtering expression matches or describes the structured data represented in the digital distributed ledger or blockchain transaction. Embodiments provide that the result of this operation is a boolean output indicating whether or not a match occurred. This boolean output is subsequently handled by the system with a record of the filter match being created in the database, and filter match notifications sent to the user. Embodiments also provides an interface through which filter expressions can be tested against a variety of pre-recorded transactions, such that the user doesn't have to wait for transactions to appear on the live blockchain to verify their filter.

Embodiments provide that endpoint notifications need not be sent to the user upon receipt of a matching transaction. Rather embodiments provide that the user can preset whether to receive endpoint notifications at the time in which a match occurs or at some other time. For example, embodiments include the user receiving endpoint notifications at preset time intervals (e.g., all matching transactions within 15 minute intervals), or when the number of matching transactions reach a predetermined value (e.g., when there are at least 50 matching transactions).

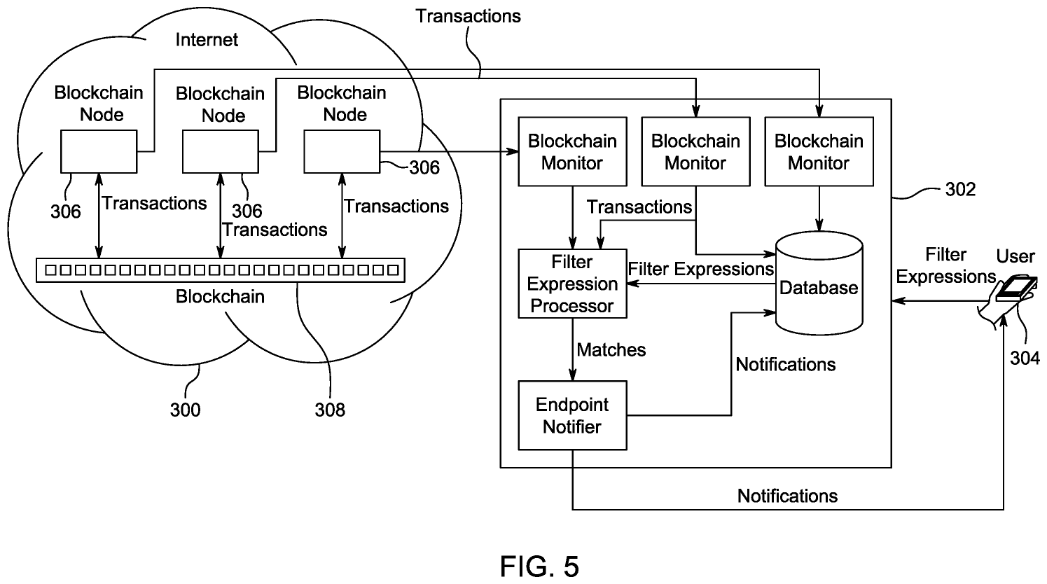

Referring to FIG. 5, shown is yet another exemplary signaling diagram in accordance with embodiments of this disclosure. In FIG. 5, server 302 is operable to monitor multiple blockchain nodes 306 such that each blockchain monitor monitors at least one of a plurality of blockchain nodes 306. Embodiments of the arrangement illustrated in FIG. 5 allow for redundancy and a distributed workload because each blockchain monitor of server 302 is operable to process or handle a fraction of blockchain data. In other words, server 302 is operable to simultaneously monitor multiple blockchain nodes 306 such that the transactions are split up and processed in parallel to reduce the time required to analyze them. This embodiment allows multiple blockchain nodes 306 to be analyzed independently. For instance, in the case of pre-validated transaction, one or more blockchain nodes 306 may have transactions that are not present on other nodes (because the transactions have not been validated).

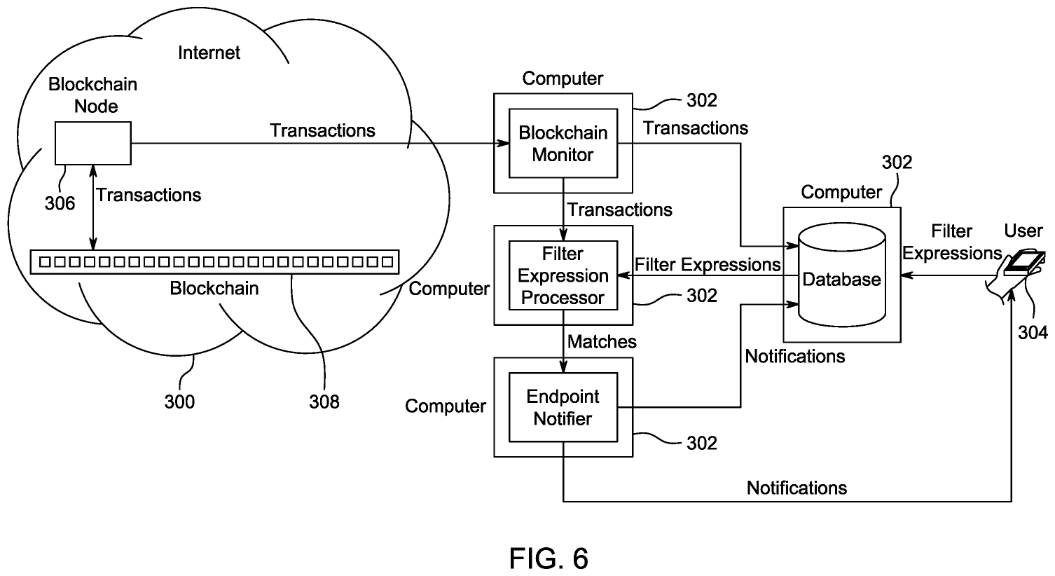

Referring to FIG. 6, shown is another exemplary signaling diagram in suitable for use in performing embodiments of this disclosure. FIG. 6 includes multiple servers 302 located in either the same location or at different locations. Each server 302 is operable to monitor transactions on a different node 306 of the digital distributed ledger 308. It should also be appreciated that in this embodiment, each of the servers 302 are performing a different function. One server 302 is monitoring the blockchain node 306. Another server 302 is receiving the user selected or created filtering expressions from a server 302 that is maintaining a database of the filtering expressions and is determining whether any of the transactions on the blockchain match the filtering expressions. Then another server 302 is notifying the UE 304 as to the transactions that match the filtering expressions. It should be appreciated that embodiments include one or more servers 302 being operable to perform one or more functions as described herein.

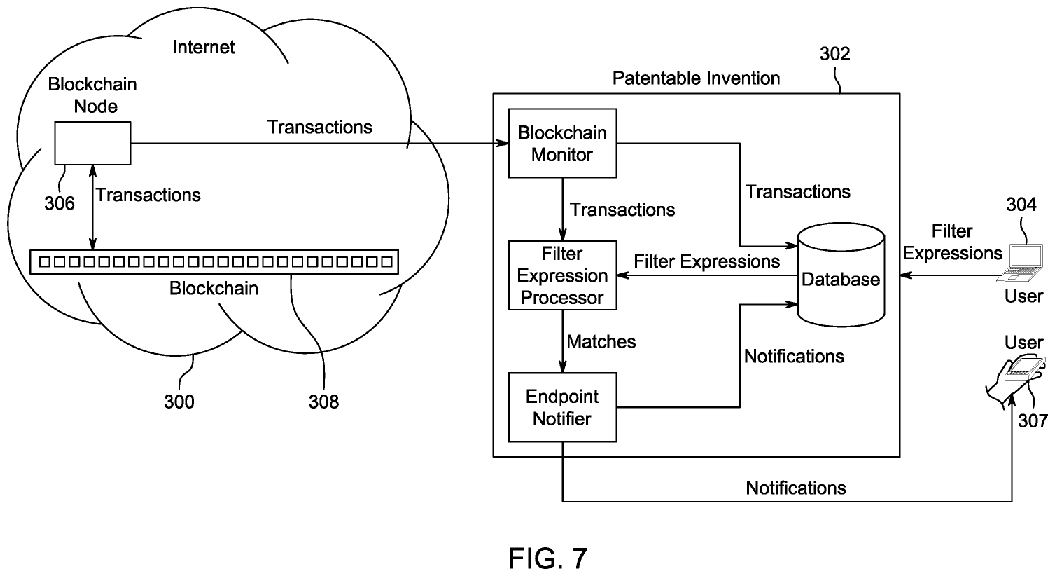

Reference is now made to FIG. 7, which illustrates yet another exemplary signaling diagram suitable for performing embodiments of this disclosure. FIG. 7 depicts an exemplary server 302 that is operable to monitor a blockchain node 306. In this embodiment, server 302 is operable to receive filtering expressions from UE 304 and transmit transactions that match the filtering expression to a different UE 307. It should be appreciated that embodiments of this disclosure include the server 302 transmitting the transactions that match the filtering expression to (i) the same UE 304 that created the filtering expressions, (ii) a UE 307 (different from the UE 304), and (iii) a plurality of UEs. It should also be appreciated that embodiments include either the UE 304, UE 307 or a different UE identifying the particular one or more UEs that will receive the transactions from the server 302.

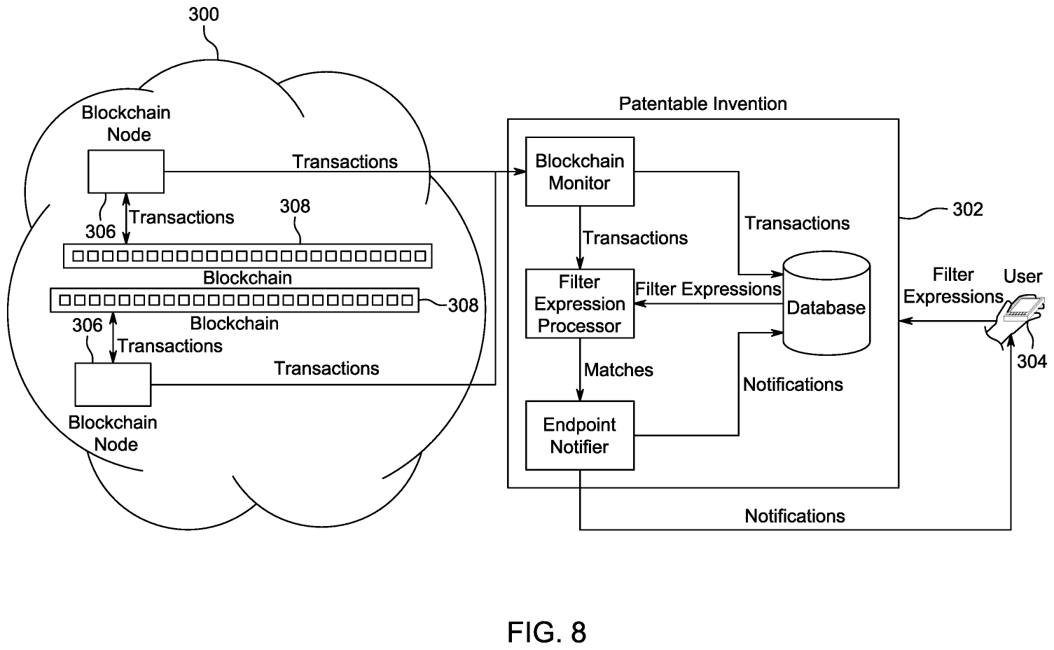

Referring to FIG. 8, shown is another exemplary signaling diagram suitable for performing embodiments of this disclosure. FIG. 8 illustrates two blockchains 308 that each include a different blockchain node 306. In this embodiment, server 302 is operable to monitor transactions on both blockchain nodes 306 for transactions on different blockchains 308. In this embodiment, a UE 304 can create or provide a filtering expression that will be applied to one or both blockchains 308. It should also be appreciated that embodiments include UE creating or providing different filtering expressions for each blockchain 308 such that server 302 applies a different filtering expression to each blockchain 308 and the user receives transactions based on matches to the different filtering expressions.

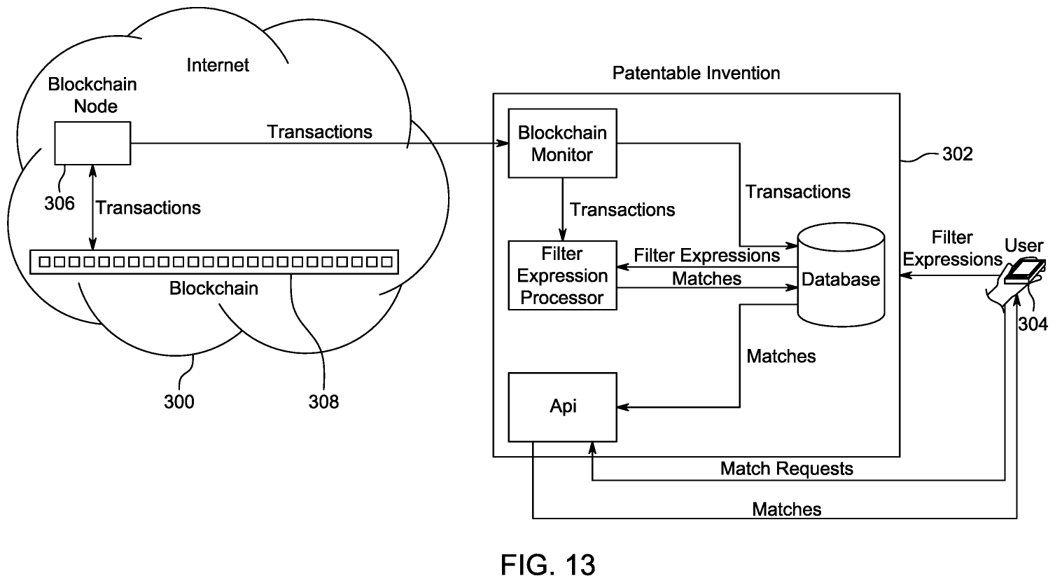

Reference is now made to FIG. 13, which illustrates yet another exemplary signaling diagram suitable for use in performing embodiments of this disclosure. FIG. 13 depicts a blockchain 308 that monitored by a blockchain node 306. Server 302 is operable to monitor transactions on blockchain node 306 and then communicate the transactions to UE 304 based on filtering expressions it receives from UE 304. In this embodiment, UE 304 transmits filtering expressions to server 302, but server 302 does not automatically transmit transactions that match or have a correspondence to those filtering expressions to UE 304. Rather, in this embodiment, after receiving the filtering expression(s) from UE 304, server 302 maintains the transactions that match or have a correspondence to the filtering expression(s) in its memory and/or database. UE 304 can then transmit to server 302 a request for the transaction(s) that match or have a correspondence to the filtering expression(s). Upon receiving the request from the UE 304, server 302 will transmit the requested transactions to UE 304 or another UE(s) as designated by UE 304. In this embodiment, UE 304 can receive the transaction(s) that match or have a correspondence to the filtering expression on upon request.

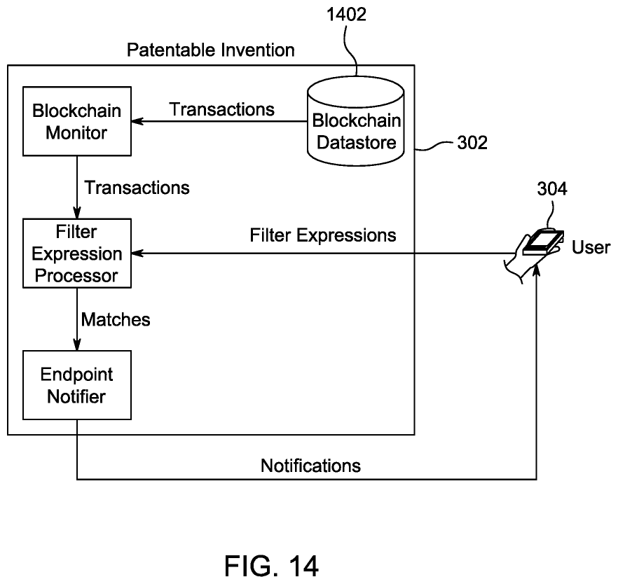

Referring now to FIG. 14, shown is a signaling diagram between server 302 and UE 304 in another exemplary embodiment of the present disclosure. Shown in FIG. 14 is server 302 and UE 304. In this embodiment, server 302 includes a blockchain datastore 1402. Blockchain datastore 1402 is a not a blockchain or a blockchain node. Rather, blockchain datastore 1402 is a historical list of transactions that have occurred on one or more blockchains. Although blockchain datastore 1402 is shown in FIG. 14 as being located or maintained within server 302 (e.g., within the memory of server 302), embodiments include blockchain datastore 1402 being separate and distinct from server 302. For instance, embodiments include blockchain datastore 1402 being maintained by a separate server, computer, or other data storage device (e.g., USB drive, hard drive, etc.). In the embodiment in which blockchain datastore 1402 is separate from server 302, the device that maintains the blockchain datastore 1402 will be operable to communicate with server 302 (e.g., via wired or wireless connection) such that server 302 can receive the transactions maintained within blockchain datastore 1402. In practice, this embodiment will include requesting, by the server 302, one or more transactions that are maintained by a blockchain datastore 1402. Next, the server 302 will receive a filtering expression from a user equipment (UE) 304, the filtering expression will include search parameters for identifying transactions on the blockchain datastore 1402. The process will then include determining, by the server 302, that at least one of the plurality of transactions on the blockchain datastore 1402 has a correspondence with the filtering expression. The process will continue by transmitting, by the server 302, either an alert that there are transactions that match the filtering expressions or the transactions themselves to the UE 304. Alternatively, server 302 may store the determined transactions until the UE 304 or another UE requests that the transactions be sent to the UE 304 or another UE.

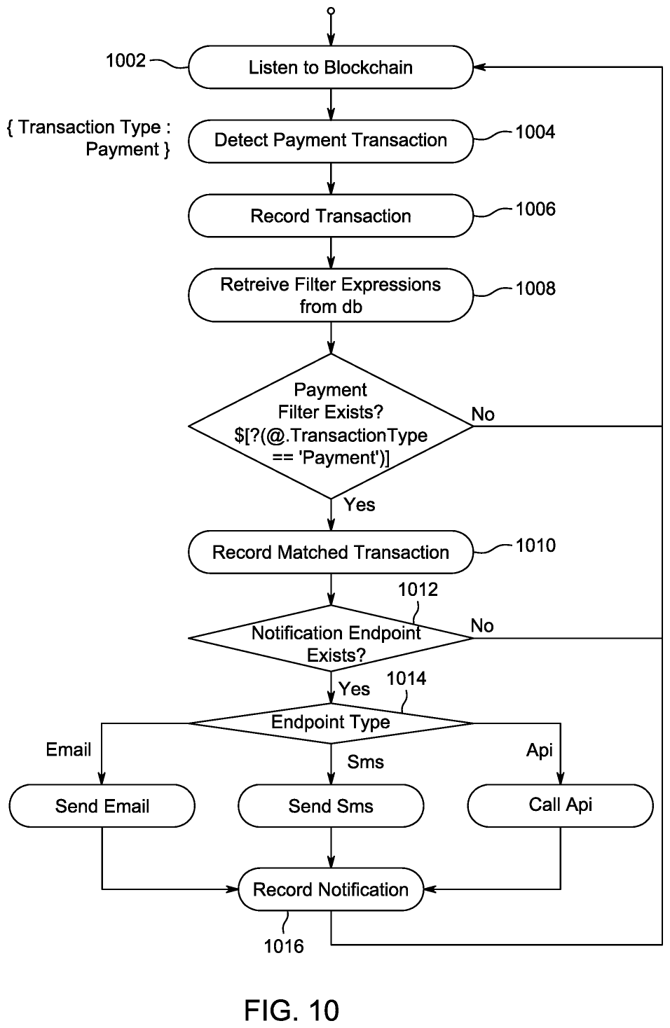

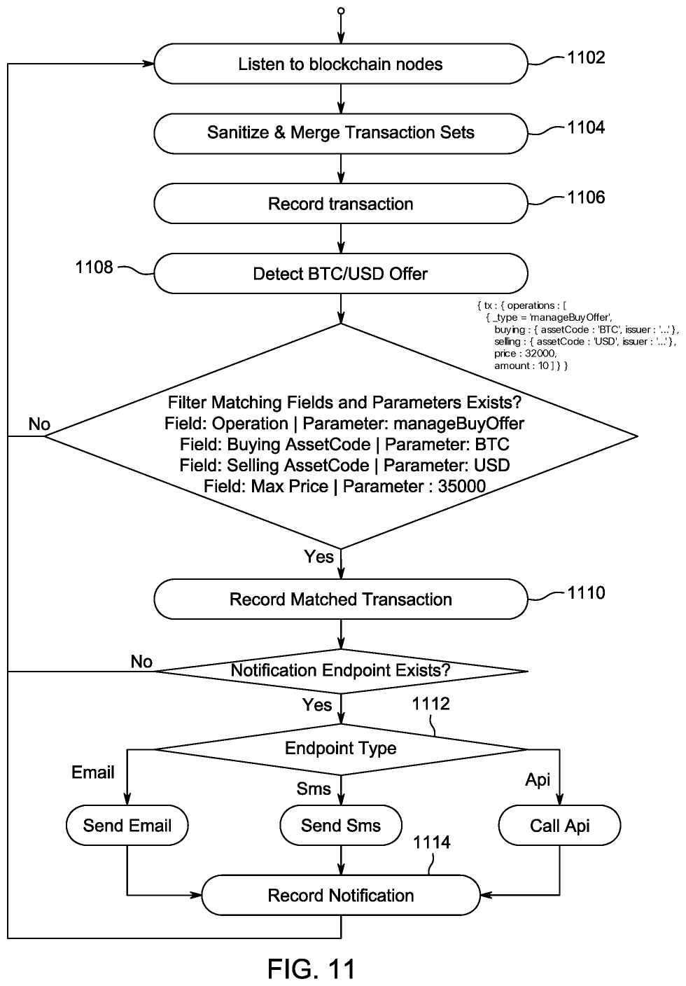

An exemplary method or process in accordance with embodiments of this disclosure are illustrated in the logic flow diagrams of FIGS. 10 and 11. Similar to FIG. 2, the process begins at block 1002 with the server 302 listening or monitoring a blockchain. This includes monitoring transactions that occur on a digital distributed ledger 308. Next at block 1004, the server 302 will detect from the transaction that there is a particular type of transaction such as a payment transaction. At block 1006, the server 302 will record the identified transaction in its memory such as in the database. Then at block 1008, the server 302 will retrieve the filtering expressions that have been set by a user in its database or memory. The server 302 by its processor will determine whether the transaction is in fact a payment transaction. If no, then the process will go back to block 1002 and server 302 will continue to monitor the digital distributed ledger 308. If yes, the process will proceed to block 1010 at which point the server 302 and its processor will determine whether the transaction matches the filtering expression set by the user. If no, then the process will go back to block 1002 and server 302 will continue to monitor the digital distributed ledger 308. If yes, then the process will proceed to block 1014 at which point an alert or notification will be sent to the user's UE 304. Embodiments of alerts can be set or specified by the UE 304 prior to the transaction being identified by the server 302 and can include sending an email, an SMS message or api call. Embodiments of the alert can include identifying characteristics of the identified transaction including the entities performing the transaction, the amounts involved in the transaction, the location of the sending/receiving in the transaction and any other parameter which may have been the basis of the filtering expression. Lastly at block 1016, the server 302 will record that a notification within its memory such as in the database. Once the notification is sent to the UE 304, the process will continue by returning to block 1002.

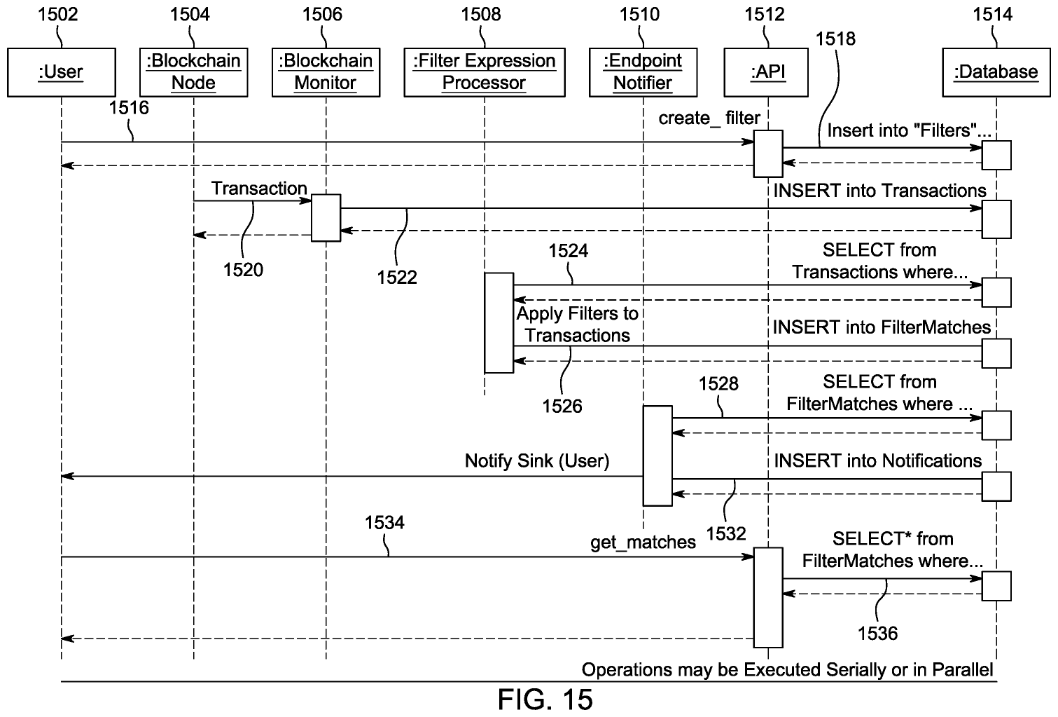

FIG. 15 illustrates a similar process as that set forth in FIG. 10, but in a sequencing diagram. Shown in FIG. 15 is user 1502, blockchain node 1504, blockchain monitor 1506, filter expression processor 1508, endpoint notifier 1510, API 1512, and database 1514. The process begins at line 1516 in which the user 1502 creates a filtering expression and transmits it to the API 1512 of a server. The API 1512 will then at line 1518 save the filtering expression to the database 1514. Next, the blockchain node 1504 will have its transactions monitored by the server's blockchain monitor 1506 at line 1520. At line 1522, the blockchain monitor 1506 will insert the monitored transactions into the database 1514. At line 1524, the filter expression processor 1508 of the server will analyze the transactions in database 1514. At line 1526, the filter expression processor 1508 will apply the filtering expression to the transactions in the database 1514 to determine whether there are any matches or correspondence between the filtering expression and the transactions. If there is a match or correspondence, the endpoint notifier 1510, at line 1528, will select the matching transactions and at line 1530 transmit to the user 1502 that there are matching transactions. At line 1534, user 1502 will request the matching transactions. At line 1536, the API 1512 will obtain or retrieve the matching transactions so that they can be transmitted to the user 1502.

Reference is now made to the FIG. 11, whose process begins at block 1102 with server 302 listening or monitoring the blockchain nodes. This can include monitoring one or more nodes on the digital distributed ledger 308. Then at block 1104, server 302 will sanitize and merge transaction sets that are monitored. Sanitize refers to removing information or data from the transaction data that are not useful or useable. For instance, some data in blockchain transactions can contain “null bytes” (i.e., all zeros) which is not acceptable for storage in certain databases. Also, not all data from blockchain can be used/stored properly such as blockchain instructions and random text. The system detects these and replaces them with a value that is able to be stored and processed. Merging occurs when a server or servers are monitoring transactions on different blockchain nodes. For example, if Node A transmits transactions 1, 2, and 3 and Node B transmits transactions 2, 3, and 4, the invention needs to merge those transactions sets such that only one copy of transactions 1, 2, 3, and 4 are written to the database for subsequent processing by filter expressions.

Next at block 1106, the transactions will be recorded in the memory and/or database of server 302. Next at block 1108 server 302 will detect whether the transaction or transactions match the filtering expression. For example, in block 708, the system is detecting whether a particular transaction is an offer to convert bitcoin into US dollars. However, it should be appreciated that embodiments include detecting or determining whether a recorded transaction matches or meets the filtering expression parameters set by the user. If the transaction matches the filtering expression, then the transaction will be recorded at block 1110. If the transaction does not match then the process will go back to block 1102 and begin the process over. If there is no notification endpoint then the process will proceed to block 1102. If there is a notification endpoint then the process will proceed to block 1112, at which point the user and/or UE 304 will receive an email, SMS message or call api notifying the UE 304 of the transaction. At block 1114, the notification will be recorded in the memory and/or database of server 302 and the process can begin again at block 1102. It should be appreciated that embodiments include the steps illustrated in the logic flow diagrams shown in FIGS. 10-12 being performed in parallel with one another.

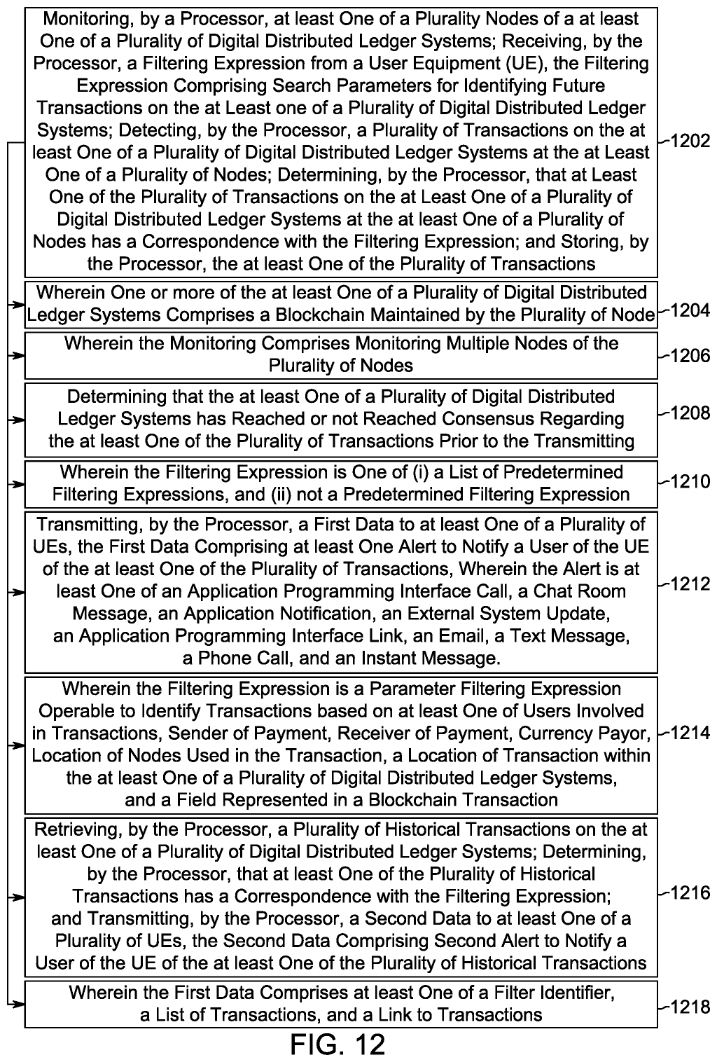

Referring now to FIG. 12, shown is yet another exemplary logic flow diagram in accordance with a method or process suitable for performing embodiments of this disclosure. Block 1202 presents monitoring, by a processor, at least one of a plurality nodes of a at least one of a plurality of digital distributed ledger systems; receiving, by the processor, a filtering expression from a user equipment (UE), the filtering expression comprising search parameters for identifying future transactions on the at least one of a plurality of digital distributed ledger systems; detecting, by the processor, a plurality of transactions on the at least one of a plurality of digital distributed ledger systems at the at least one of a plurality of nodes; determining, by the processor, that at least one of the plurality of transactions on the at least one of a plurality of digital distributed ledger systems at the at least one of a plurality of nodes has a correspondence with the filtering expression; and storing, by the processor, the at least one of the plurality of transactions. Next, block 1204 states wherein the at least one of a plurality of digital distributed ledger systems comprises a blockchain maintained by the plurality of node.

Some of the non-limiting implementations detailed above are also summarized at FIG. 12 following block 1204. Block 1206 states wherein the monitoring comprises monitoring multiple nodes of the plurality of nodes. Then block 1208 relates to determining that the at least one of a plurality of digital distributed ledger systems has reached or not reached consensus regarding the at least one of the plurality of transactions prior to the transmitting. Block 1210 then specifies wherein the filtering expression is one of (i) a list of predetermined filtering expressions, and (ii) not a predetermined filtering expression. Block 1212 indicates transmitting, by the processor, a first data to at least one of a plurality of UEs, the first data comprising at least one alert to notify a user of the UE of the at least one of the plurality of transactions, wherein the alert is at least one of an application programming interface call, a chat room message, an application notification, an external system update, an application programming interface link, an email, a text message, a phone call, and an instant message. Block 1214 then states wherein the filtering expression is a parameter filtering expression operable to identify transactions based on at least one of users involved in transactions, sender of payment, receiver of payment, currency payor, location of nodes used in the transaction, a location of transaction within the at least one of a plurality of digital distributed ledger systems, and a field represented in a blockchain transaction. Next, block 1216 specifies retrieving, by the processor, a plurality of historical transactions on the at least one of a plurality of digital distributed ledger systems; determining, by the processor, that at least one of the plurality of historical transactions has a correspondence with the filtering expression; and transmitting, by the processor, a second data to at least one of a plurality of UEs, the second data comprising second alert to notify a user of the UE of the at least one of the plurality of historical transactions. Finally, block 1218 states wherein the first data comprises at least one of a filter identifier, a list of transactions, and a link to transactions.

The logic diagram of FIG. 12 may be considered to illustrate the operation of a method or a result of execution of computer instructions stored in a computer-readable medium. The logic diagram of FIG. 12 may also be considered a specific manner in which components of a device are configured to cause that device to operate, whether such a device is a server, computer, smart phone, tablet, wearable, or other electronic device, or one or more components thereof.

Embodiments of the present invention have been described in detail with particular reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method of monitoring, the method comprising:
monitoring, by a processor, at least one of a plurality nodes of at least one of a plurality of digital distributed ledger systems;
receiving, by the processor, a filtering expression from a user equipment (UE), the filtering expression comprising search parameters for identifying future transactions on the at least one of a plurality of digital distributed ledger systems;
detecting, by the processor, a plurality of transactions on the at least one of a plurality of digital distributed ledger systems at the at least one of a plurality of nodes;
determining, by the processor, that at least one of the plurality of transactions on the at least one of a plurality of digital distributed ledger systems at the at least one of a plurality of nodes has a correspondence with the filtering expression; and
storing, by the processor, the at least one of the plurality of transactions.

2. The method according to claim 1, wherein one or more of the at least one of a plurality of digital distributed ledger systems comprises a blockchain maintained by the plurality of node.

3. The method according to claim 1, wherein the monitoring comprises monitoring multiple nodes of the plurality of nodes.

4. The method according to claim 1, the method further comprising determining that the at least one of a plurality of digital distributed ledger systems has reached consensus regarding the at least one of the plurality of transactions prior to the transmitting.

5. The method according to claim 1, the method further comprising determining that the at least one of a plurality of digital distributed ledger systems has not reached consensus regarding the at least one of the plurality of transactions prior to the transmitting.

6. The method according to claim 1, wherein the filtering expression is one of a list of predetermined filtering expressions.

7. The method according to claim 1, wherein the filtering expression is not a predetermined filtering expression.

8. The method according to claim 1, the method further comprising transmitting, by the processor, a first data to at least one of a plurality of UEs, the first data comprising at least one alert to notify a user of the UE of the at least one of the plurality of transactions, wherein the alert is at least one of an application programming interface call, a chat room message, an application notification, an external system update, an application programming interface link, an email, a text message, a phone call, and an instant message.

9. The method according to claim 1, wherein the filtering expression is a parameter filtering expression operable to identify transactions based on at least one of users involved in transactions, sender of payment, receiver of payment, currency payor, location of nodes used in the transaction, a location of transaction within the at least one of a plurality of digital distributed ledger systems, and a field represented in a blockchain transaction.

10. The method according to claim 1, the method further comprising retrieving, by the processor, a plurality of historical transactions on the at least one of a plurality of digital distributed ledger systems; determining, by the processor, that at least one of the plurality of historical transactions has a correspondence with the filtering expression; and in response to receiving a request to transmit, transmitting, by the processor, a second data to at least one of a plurality of UEs, the second data comprising second alert to notify a user of the UE of the at least one of the plurality of historical transactions.

11. The method according to claim 8, wherein the first data comprises at least one of a filter identifier, a list of transactions, and a link to transactions.

12. An apparatus comprising at least one processor and at least one memory storing computer program instructions executable by the at least one processor, wherein the at least one memory with the computer program instructions and the at least one processor are configured to cause the apparatus to at least:
monitoring, by a processor, at least one of a plurality nodes of a at least one of a plurality of digital distributed ledger systems;
receive a filtering expression from a user equipment (UE), the filtering expression comprising search parameters for identifying future transactions on the at least one of a plurality of digital distributed ledger systems;
detect a plurality of transactions on the at least one of a plurality of digital distributed ledger systems at the at least one of a plurality of nodes;
determine that at least one of the plurality of transactions on the at least one of a plurality of digital distributed ledger systems at the at least one of a plurality of nodes has a correspondence with the filtering expression; and
transmit a first data to the UE, the first data comprising at least one alert to notify a user of the UE of the at least one of the plurality of transactions.

13. The apparatus according to claim 12, wherein the at least one of a plurality of digital distributed ledger systems comprises a blockchain maintained by the plurality of node.

14. The apparatus according to claim 12, wherein the monitoring comprises monitoring multiple nodes of the plurality of nodes.

15. The apparatus according to claim 12, the apparatus being further caused to determine that the at least one of a plurality of digital distributed ledger systems has reached consensus regarding the at least one of the plurality of transactions prior to the transmitting.

16. The apparatus according to claim 12, wherein the filtering expression is one of a list of predetermined filtering expressions.

17. The apparatus according to claim 12, wherein the filtering expression is not a predetermined filtering expression.

18. The apparatus according to claim 12, wherein the alert is at least one of an application programming interface call, an application programming interface link, an email, a text message, a phone call, and an instant message.

19. The apparatus according to claim 12, the apparatus is further caused to retrieve a plurality of historical transactions on the at least one of a plurality of digital distributed ledger systems;
determine that at least one of the plurality of historical transactions has a correspondence with the filtering expression; and in response to receiving a request to transmit, transmit a second data to at least one of a plurality of UEs, the second data comprising second alert to notify a user of the UE of the at least one of the plurality of historical transactions.

20. A non-transitory computer-readable medium tangibly storing computer program instructions which when executed by a processor, cause the processor to at least:
monitor at least one of a plurality nodes of a at least one of a plurality of digital distributed ledger systems;
receive a filtering expression from a user equipment (UE), the filtering expression comprising search parameters for identifying future transactions on the at least one of a plurality of digital distributed ledger systems;
detect a plurality of transactions on the at least one of a plurality of digital distributed ledger systems at the at least one of a plurality of nodes;
determine that at least one of the plurality of transactions on the at least one of a plurality of digital distributed ledger systems at the at least one of a plurality of nodes has a correspondence with the filtering expression; and
transmit a first data to the UE, the first data comprising at least one alert to notify a user of the UE of the at least one of the plurality of transactions.

21. The non-transitory computer-readable medium according to claim 20, wherein the monitoring comprises monitoring multiple nodes of the plurality of nodes.

22. The non-transitory computer-readable medium according to claim 20, wherein the filtering expression is one of a list of predetermined filtering expressions.

23. The non-transitory computer-readable medium according to claim 20, wherein the filtering expression is not a predetermined filtering expression.

24. The non-transitory computer-readable medium according to claim 20, wherein the alert is at least one of an application programming interface call, an application programming interface link, an email, a text message, a phone call, and an instant message.

25. The non-transitory computer-readable medium according to claim 20, the process is further caused to determine that the at least one of a plurality of digital distributed ledger systems has reached consensus regarding the at least one of the plurality of transactions prior to the transmitting.

26. The non-transitory computer-readable medium according to claim 20, the processor is further caused to retrieve a plurality of historical transactions on the at least one of a plurality of digital distributed ledger systems; determine that at least one of the plurality of historical transactions has a correspondence with the filtering expression; and in response to receiving a request to transmit, transmit a second data to at least one of a plurality of UEs, the second data comprising second alert to notify a user of the UE of the at least one of the plurality of historical transactions.

27. A method comprising:
receiving, by the processor, a filtering expression from a user equipment (UE), the filtering expression comprising search parameters for identifying future transactions on the digital distributed ledger system;
determining, by the processor, that at least one of the plurality of transactions from a blockchain datastore has a correspondence with the filtering expression; and
transmitting, by the processor, the at least one of the plurality of transactions to the UE.

28. The method according to claim 27, wherein the plurality of transaction from the blockchain datastore is based on transactions from a blockchain.

29. The method according to claim 27, wherein the transmitting occurs in response to receiving a request from the UE for the at least one of the plurality of transactions.

30. The method according to claim 27, the method further comprising transmitting, by the processor, a first data to at least one of a plurality of UEs, the first data comprising at least one alert to notify a user of the UE of the at least one of the plurality of transactions.

31. The method according to claim 27, wherein the transmitting occurs in response to the at least one of the plurality of transactions meeting a predetermined threshold, and wherein the predetermined threshold is at least one of (i) a predetermined time between transmitting, and (ii) the at least one of the plurality of transactions meeting a predetermined number of transactions.

32. The method according to claim 27, wherein the transmitting is performed in response to receiving, by the processor, a request from the UE to transmit.
